(19) United States
(12) Patent Application Publication
(10) Pub. No.: US 2005/0134579 A1
(43) Pub. Date: Jun. 23, 2005

(54) Wirelessly driven display system

(76) Inventors: Tsau-Hua Hsieh, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/741,673

(22) Filed: Dec. 19, 2003

(51) Int. Cl. G09G 5/00

(52) U.S. Cl. 345/204

(57) ABSTRACT

The present invention provides a display system (200) for wirelessly driving display devices. In one embodiment, the display system includes a signal processing unit (210), an interface unit (220) having a control unit (222), a first antenna (201), a second antenna (202) and a display device (230). In contrast to a conventional wirelessly driven display system, the control unit of the present invention is integrated into the interface unit. By doing so, the display area of the display device may be enlarged. Furthermore, the display system may also allow two-way communication between the display device and the signal processing unit by incorporating an input signal detector.

### BACKGROUND OF THE INVENTION

1. Field of the Invention

The present invention relates generally to a display system, and more particularly, to a display system that is operated by means of wireless connections.

2. Prior Art

Conventionally, a display device, such as a liquid crystal display, is connected to a signal generation device, such as a personal computer, through cables. However, cable connections between a display device and a signal generation device limit the distance between the display device and the signal generation device to the length of the cable used. Further, as more and more peripheral devices are connected to the signal generation device, a large amount of cables needs to be employed, resulting in inconvenient and unmanageable wiring and poor aesthetic appearance. Thus, wireless connections between signal generation devices and peripheral devices are gradually replacing cable connections.

U.S. Pat. No. 6,492,973 issued to Kuroki et al. teaches a “method of driving a flat display capable of wireless connection and device for driving the same.” FIG. 3 shows a pertinent conventional display system 300. The display system 300 comprises a signal generation unit 310, a modulator 320, a transmitter 330, a first antenna 301, a second antenna 302, a receiver 340, a demodulator 350, a control unit 360, an x-direction driving circuit 361, a y-direction driving circuit 362, and a display panel 363. The signal generation unit 310 generates the signals to be displayed, and sends the signal to the modulator 320. The modulator 320 then modulates the signals to be displayed into radio frequency waves, and sends the radio frequency waves to the transmitter 330. The transmitter 330 sends out the radio frequency waves 303 through the first antenna 301. The receiver 340 then receives the radio frequency waves 303 sent from the first antenna 302 through the second antenna 302, and sends the received radio frequency waves 303 to the demodulator 350. The demodulator 350 demodulates the radio frequency waves, and recovers them into the signals to be displayed. The control unit 360 then converts the signals to be displayed from the demodulator 350 into x-direction image signals and y-direction image signals. The x-direction driving circuit 361 and the y-direction driving circuit 362 then take the x-direction image signals and the y-direction image signals, respectively, from the control unit 360, and drive the display panel 363 in accordance with the x-direction image signals and the y-direction image signals.

However, in accordance with the teachings of Kuroki et al., the control unit 360 as shown in FIG. 3 is integrated in the display device; that is, at the side of the second antenna 302, which limits the display module size of the display device from further shrinking. In addition, Kuroki et al.'s teaching only provides one-way communication between a signal generation unit and a display device. In many contemporary applications, a touch-screen display device is needed for receiving input signals from the display device. This is not provided in the teaching of Kuroki et al.

### SUMMARY OF THE INVENTION

One objective of the present invention is to provide a display system such that a control unit is integrated into an interface unit at a side of a first antenna, so as to shrink the display module size of a display device.

Another objective of the present invention is to provide a display system that receives input signals from the display device.

To achieve the above and other objectives, the present invention, in accordance with one particular embodiment, discloses a display system comprising a signal generation unit, an interface unit comprising a control unit and a transmitting unit, a first antenna, a second antenna, and a display device comprising a receiving unit, a display panel, an x-direction driver and a y-direction driver. The control unit of this particular embodiment is integrated in the interface unit so as to shrink the display module size of the display device.

In accordance with another particular embodiment of the present invention, a display system is disclosed comprising a signal processing device, an interface unit comprising a control unit and a first transceiver unit, a first antenna, a second antenna, and a touch-screen display device comprising a second transceiver unit, a touch-screen display panel, an x-direction driver and a y-direction driver. The control unit of this particular embodiment is also integrated in the interface unit so as to shrink the display module size of the display device, while the touch-screen display device is capable of two-way communication between the display device and the signal processing device.

### BRIEF DESCRIPTION OF THE DRAWINGS

The present invention is better understood by referring to the detailed description of the preferred embodiment taken in conjunction with the drawings, in which like reference numerals denote like elements, and wherein:

FIG. 1 is a block diagram illustrating a display system in accordance with one embodiment of the present invention;

FIG. 2 is a block diagram illustrating a display system, in accordance with another embodiment of the present invention; and

FIG. 3 is a block diagram illustrating a conventional display system.

### DETAILED DESCRIPTION OF THE INVENTION

Referring to FIG. 1 a display system 100 in accordance with one particular embodiment of the present invention is illustrated. The display system 100 comprises a signal generation device 110, an interface unit 120 comprising a transmitting unit 121 and a control unit 122, a first antenna 101, a second antenna 102, and a display device 130 comprising a receiving unit 131, a x-direction driver 132, a y-direction driver 133 and a display panel 134. In this particular embodiment, the signal generation unit 110 is a personal computer, while in other particular embodiments, the signal generation unit 110 may alternatively be a server computer, a personal digital assistant, a television set, a television phone or a television conference system. The display device 130 in this particular embodiment is a thin film transistor liquid crystal display (TFT-LCD) device. The display device 130 may alternatively be a cathode ray tube (CRT) display device. The first antenna 101 and the second antenna 102 are capable of sending and receiving, respectively, radio frequency waves 103. In this particular embodiment, the radio frequency waves 103 are millimeter waves, i.e. the wavelengths of the radio frequency waves 103 are of the order of millimeters.

In FIG. 1, the signal generation unit 110 generates signals to be displayed. The control unit 122 then receives the signals to be displayed from the signal generation unit 110, and converts the signals to be displayed into driving signals. The driving signals are signals for driving the display device 130. The transmitting unit 121 receives the driving signals from the control unit 122, and converts the driving signals into radio frequency waves 103. The first antenna 101 sends out the radio frequency waves 103 from the transmitting unit 121, while the second antenna 102 receives the radio frequency waves 103 sent from the first antenna 101. The receiving unit 131 then receives the radio frequency waves 103 from the second antenna 102, and converts the radio frequency waves 103 into the driving signals. The receiving unit 131 further separates the driving signals into x-direction image signals and y-direction image signals. The display panel 134 has a plurality of display pixels (not shown) arranged in rows and columns. Since the structure of the display pixels (not shown) is known in the art, illustration of them is omitted. The display panel 134 comprises an x-direction drive line 135 arranged for each row of the display pixels, and a y-direction drive line 136 arranged for each column of the display pixels. The x-direction driver 132 supplies the x-direction drive line 135 with the x-direction image signals received from the receiving unit 131, while the y-direction driver 133 supplies the y-direction drive line 136 with the y-direction image signals from the receiving unit 131.

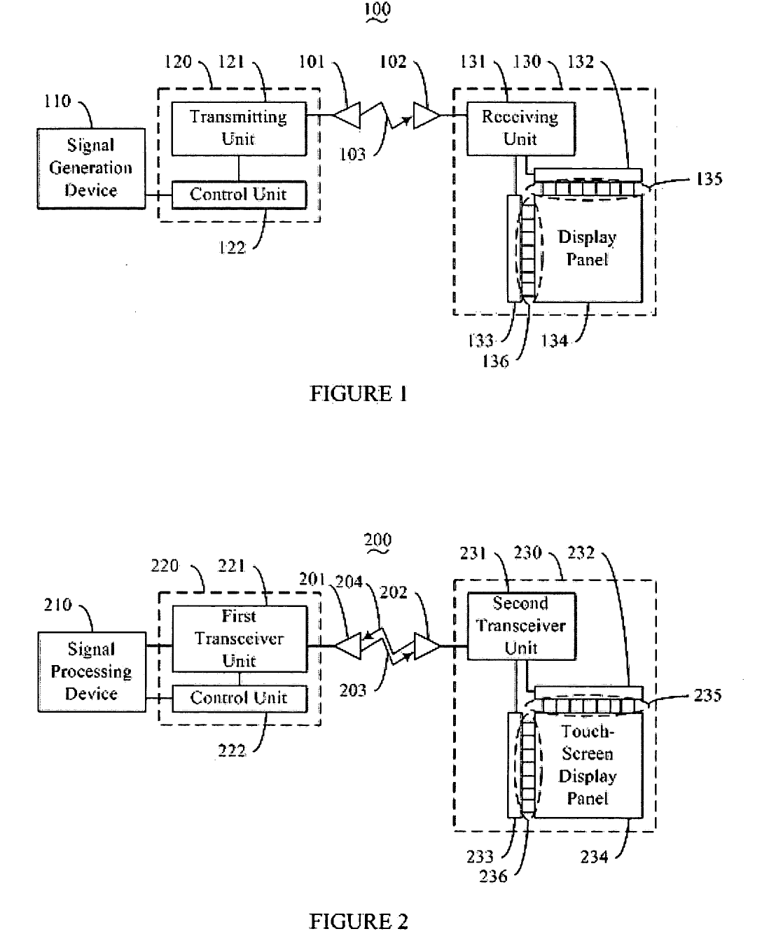

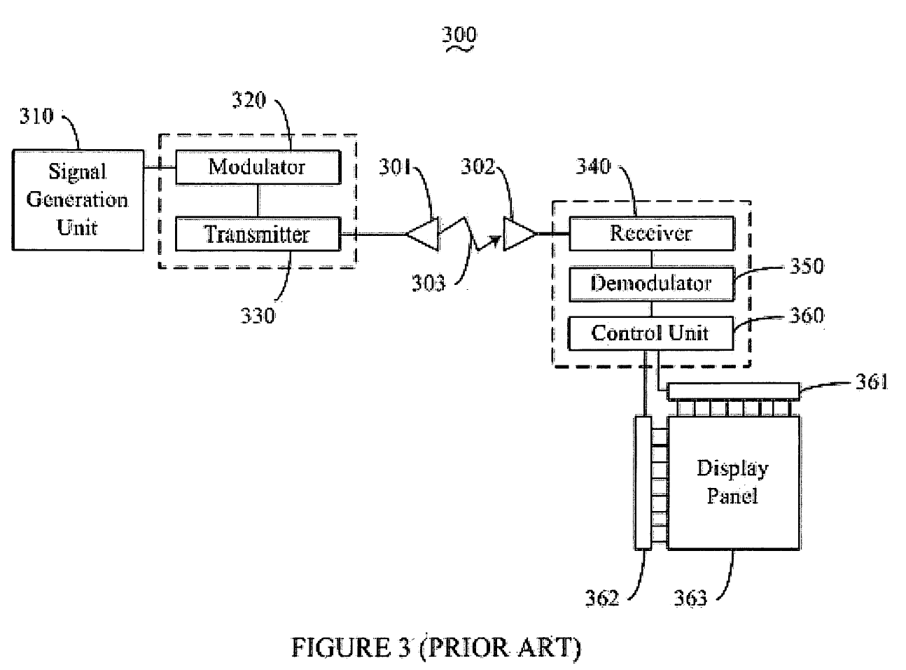

Referring now to FIG. 2 a display system 200 in accordance with another particular embodiment of the present invention is illustrated. The display system 200 comprises a signal processing device 210, an interface unit 220 comprising a first transceiver unit 221 and a control unit 222, a first antenna 201, a second antenna 202, and a display device 230 comprising a second transceiver unit 231, a x-direction driver 232, a y-direction driver 233 and a touch-screen display panel 234. In this particular embodiment, the signal processing unit 210 is a personal computer, while in other particular embodiments, the signal processing unit 210 may alternatively be a server computer, a personal digital assistant, a television set, a television phone or a television conference system. The display device 230 in this particular embodiment is a thin film transistor liquid crystal display (TFT-LCD) device. The display device 230 may alternatively be a cathode ray tube (CRT) display device. The first antenna 201 and the second antenna 202 are capable of sending and receiving radio frequency waves 203. In this particular embodiment, the radio frequency waves 203 are millimeter waves, i.e. the wavelengths of the radio frequency waves 203 are of the order of millimeters. The touch-screen display panel 234 comprises an input signal detector (not shown) for receiving input signals from pressing of the touch-screen display panel 234 by a finger or a stylus pen.

In FIG. 2, the signal processing unit 210 generates signals to be displayed and receives input signals. The control unit 222 then receives the signals to be displayed from the signal processing unit 210, and converts the signals to be displayed into driving signals. The driving signals are signals for driving the display device 230. The first transceiver unit 221 converts the driving signals into forward radio frequency waves 203, and provides input signals for the signal processing unit 210 from backward radio frequency waves 204. The first antenna 201 sends out the forward radio frequency waves 203 from the first transceiver unit 221, and receives the backward radio frequency waves 204. The second antenna 202 receives the forward radio frequency waves 203 sent from the first antenna 201, and sends the backward radio frequency waves 204 to the first antenna 201. The second transceiver unit 231 receives the forward radio frequency waves 203 from the second antenna 202, converts the forward radio frequency waves 203 into the driving signals, separates the driving signals into x-direction image signals and y-direction image signals, and converts input signals into backward radio frequency waves 204. The touch-screen display panel 234 has a plurality of display pixels (not shown) arranged in rows and columns. Since the structure of the display pixels (not shown) is known in the art, illustration of them is omitted. The touch-screen display panel 234 comprises an x-direction signal line 235 arranged for each row of the display pixels, and a y-direction signal line 236 arranged for each column of the display pixels. Each display pixel (not shown) comprises an input signal detector (not shown) for detecting input signals. The input signal detector may be of a resistive type, a capacitive type, an optical type or an ultrasonic type. Since the structure of the input signal detector is also known in the art, illustration thereof is omitted. In this particular embodiment, the input signal detector is of a resistive type, which comprises an upper electrode (not shown) and a lower electrode (not shown) both composed of indium-tin oxide (ITO). By pressing the upper electrode and the lower electrode by a finger or a Stylus pen, one may short-circuit the upper electrode and the lower electrode. The contact point that the finger or a Stylus pen presses one the upper electrode may thereafter be derived. The x-direction driver 232 supplies the x-direction drive line 235 with the x-direction image signals, and detects the input signals in the x-direction. The y-direction driver 233 supplies the y-direction drive line 236 with the y-direction image signals, and detects the input signals in the y-direction.

While the present invention is described in detail with reference to the illustrated embodiments, it will be appreciated that no limitation is intended by the above descriptions. The particular embodiments as described above only illustrate one display device for each respective display system, as shown in FIG. 1 and FIG. 2. It will be appreciated that the display system of the present invention may drive more than one display device. Various equivalent modifications or alterations of the preferred embodiments described above will be apparent to those having ordinary skill in the art; however, they are to be construed as being exemplary of the present invention as defined in the following claims. That is, all equivalent modifications or alterations of the preferred embodiments given above are to be considered within the spirit and scope of the present invention.

1. A display system, comprising:
a signal generation device generating signals to be displayed;
an interface unit, comprising:
a control unit receiving the signals to be displayed from said signal generation unit and converting the signals to be displayed into driving signals; and
a transmitting unit converting the driving signals into radio frequency waves;
a first antenna for sending the radio frequency waves from said transmitting unit;
a second antenna for receiving the radio frequency waves sent from said first antenna; and
a display device, comprising:
a receiving unit receiving the radio frequency waves from said second antenna, converting the radio frequency waves into the driving signals, and separating the driving signals into x-direction image signals and y-direction image signals;
a display panel comprising an x-direction drive line arranged for each row of display pixels and a y-direction drive line arranged for each column of display pixels;
an x-direction driver supplying the x-direction drive line with the x-direction image signals; and
a y-direction driver supplying the y-direction drive line with the y-direction image signals.

2. The display system as recited in claim 1, wherein said signal generation device is any one of a personal computer, a server computer, a personal digital assistant, a television set, a television phone and a television conference system.

3. The display system as recited in claim 1, wherein said display panel is a liquid crystal display panel.

4. The display system as recited in claim 1, wherein the radio frequency waves are millimeter waves.

5. A display system, comprising:
a signal processing unit generating signals to be displayed and receiving input signals;
an interface unit, comprising:
a control unit receiving the signals to be displayed from said signal processing unit and converting the signals to be displayed into driving signals; and
a first transceiver unit converting the driving signals into forward radio frequency waves and providing the input signals for said signal processing unit from backward radio frequency waves;
a first antenna sending the forward radio frequency waves from said first transceiver unit and receiving the backward radio frequency waves;
a second antenna receiving the forward radio frequency waves sent from said first antenna and sending the backward radio frequency waves to said first antenna; and
a touch-screen display device, comprising:
a second transceiver unit receiving the forward radio frequency waves from said second antenna, converting the forward radio frequency waves into the driving signals and separating the driving signals into x-direction image signals and y-direction image signals, and converting input signals into backward radio frequency waves;
a touch-screen display panel comprising an x-direction signal line arranged for each row of display pixels and a y-direction signal line arranged for each column of display pixels, wherein each display pixel comprises an input signal detector;
an x-direction driver supplying the x-direction signal line with the x-direction image signals from the second transceiver unit and detecting the x-direction input signals by the input signal detector; and
a y-direction driver supplying the y-direction signal line with the y-direction image signals from the second transceiver unit and detecting the y-direction input signals by the input signal detector.

6. The display system as recited in claim 5, wherein said signal generation device is any one of a personal computer, a server computer, a personal digital assistant, a television set, a television phone and a television conference system.

7. The display system as recited in claim 5, wherein said touch-screen display panel is a liquid crystal display panel.

8. The display system as recited in claim 5, wherein the radio frequency waves are millimeter waves.

9. The display system as recited in claim 5, wherein the input signal detector is of one of a resistive type, a capacitive type, an optical type and an ultrasonic type, and is activated by pressing of a finger or a stylus pen for generating the input signals.

10. A touch-screen display device, comprising:
a transceiver unit receiving a forward radio frequency waves, converting the forward radio frequency waves into a driving signals and separating the driving signals into x-direction image signals and y-direction image signals, and converting input signals into backward radio frequency waves;
a touch-screen display panel comprising a plurality of x-direction signal lines and a plurality of y-direction signal lines, the x-direction signal lines and the y-direction lines crossing with each other for defining a plurality of display pixels, wherein each display pixel comprises an input signal detector;
an x-direction driver supplying each of the x-direction signal lines with the x-direction image signals from the transceiver unit and detecting x-direction input signals by the input signal detector; and
a y-direction driver supplying each of the y-direction signal lines with the y-direction image signals from the transceiver unit and detecting y-direction input signals by the input signal detector.

11. The touch screen display device as recited in claim 10, wherein said touch-screen display panel is a liquid crystal display panel.

12. The touch screen display device as recited in claim 10, wherein the radio frequency waves are millimeter waves.

13. The touch screen display device as recited in claim 10, wherein the input signal detector is of one of a resistive type, a capacitive type, an optical type and an ultrasonic type, and is activated by pressing of a finger or a stylus pen for generating the input signals.

14. A display device, comprising:
a receiving unit receiving radio frequency waves from an antenna, converting the radio frequency waves into driving signals, and separating the driving signals into x-direction image signals and y-direction image signals;
a display panel comprising an x-direction drive line and a y-direction drive line;
an x-direction driver supplying the x-direction drive line with the x-direction image signals; and
a y-direction driver supplying the y-direction drive line with the y-direction image signals.

15. The display device as recited in claim 14, wherein said display panel is a liquid crystal display panel.

16. The display system as recited in claim 14, wherein the radio frequency waves are millimeter waves.

17. A wirelessly driven system comprising:
an emitting device including a first antenna; and
a receiving device including a second antenna interactively communicating with the first antenna; wherein
said emitting device includes a signal generating unit, a transmitting unit and a control unit under a condition that said transmitting unit communicatively connected to said control unit and said first antenna, respectively, and said signal generating unit communicatively connected to at least said control unit; wherein
said receiving device includes a receiving unit communicatively connected to the second antenna and a display panel communicatively connected to the receiving unit.

18. The system as recited in claim 17, wherein said transmitting unit is essentially a transceiver further performing a receiving function, and said receiving unit is essentially another transceiver further performing a transmitting function so as to have said first antenna and said second antenna communicate with each other in two ways.

19. The system as recited in claim 18, wherein said signal generating unit is further communicatively and directly connected to said transceiver.

20. The system as recited in claim 17, wherein said transmitting unit is essentially directly connected to said first antenna, and said receiving unit is essentially directly connected to said second antenna.
